(19) United States
(12) Patent Application Publication
(10) Pub. No.: US 2016/0275421 A1
(43) Pub. Date: Sep. 22, 2016

(54) FUNCTION-BASED AUTOMATIC EVALUATION OF A COMPUTER ENVIRONMENT

(71) Applicant: International Business Machines Corporation, Armonk, NY (US)

(72) Inventors: Christopher J. Dawson, Arlington, VA (US); Ravi K. Kosaraju, Pittsford, NY (US); Baiju D. Mandalia, Boca Raton, FL (US); Madhusudan Ramakrishna, Bangalore (IN)

(21) Appl. No.: 14/658,657

(22) Filed: Mar. 16, 2015

(51) Int. Cl. G06Q 10/06; G06N 5/02

(52) U.S. Cl. CPC G06Q 10/067; G06N 5/02

(57) ABSTRACT

In general, embodiments of the present invention provide an approach for evaluating a computer environment. Specifically, actual deployed components of the computer systems are discovered and cross-referenced against a pre-determined functional architecture to produce a new physical pattern model to determine whether critical functions within the computer environment are not implemented or whether deployed components within the computer environment are over or under capacity.

### TECHNICAL FIELD

The present invention provides a tool for evaluating a computer environment. Specifically, the present invention provides the ability to automatically discover actual components of deployed computer systems and cross-reference them against a pre-determined functional architecture to produce a new physical pattern model.

### BACKGROUND

A data center is a facility used to house a collection of computer systems and associated components, such as telecommunications and storage systems. It generally includes redundant or backup power supplies, redundant data communications connections, environmental controls and various security devices. Data centers are typically used by organizations for the remote storage, processing, or distribution of large amounts of data.

Computer systems may be implemented based on a predetermined functional architecture. The predetermined functional architecture may include a best practice or reference architecture. A reference architecture provides a template solution for an architecture for a particular domain. It also provides a common vocabulary with which to discuss implementations, often with the aim to stress commonality. A reference architecture may include a series of functional components that may be required for a specific solution. When the components are implemented, one or more components may be implemented incorrectly due to a change in requirements in which the infrastructure was not updated accordingly.

In addition, situations exist in which the inventory of existing equipment may not be accurate as system integrators and service providers transition outsourced data centers. This can lead to unexpected problems in the transition process and service management design. The issues include configuration of equipment and age of equipment which can lead to failures due to negligence on standard maintenance procedures. Also, in a situation where one company takes over management of equipment from another company, proprietary data may be deleted. This makes it difficult to get the configuration information and may slow the transition.

### SUMMARY

In general, embodiments of the present invention provide an approach for evaluating a computer environment. Specifically, actual deployed components of the computer systems are discovered and cross-referenced against a pre-determined functional architecture to produce a new physical pattern model to determine whether critical functions within the computer environment are not implemented or whether deployed components within the computer environment are over or under capacity.

One aspect of the present invention includes a method for evaluating a computer environment, comprising the computer-implemented steps of: deriving a set of use cases; selecting a predefined reference architecture using the set of defined use cases; deriving a set of scenarios from the set of use cases; deriving a set of system components from the set of derived scenarios; customizing the selected reference architecture based on the set of derived components; discovering installed components in the computer environment; deriving a business pattern from at least one of the customized reference architecture and installed components; discovering existing documentation related to the computer environment; and deriving a physical model pattern from the business pattern and existing documentation.

A second aspect of the present invention provides a system for evaluating a computer environment, comprising: a memory medium comprising program instructions; a bus coupled to the memory medium; and a processor, for executing the program instructions, coupled to the memory medium that when executing the program instructions causes the system to: derive a set of use cases; select a predefined reference architecture using the set of defined use cases; derive a set of scenarios from the set of use cases; derive a set of system components from the set of derived scenarios; customize the selected reference architecture based on the set of derived components; discover installed components in the computer environment; derive a business pattern from at least one of the customized reference architecture and installed components; discover existing documentation related to the computer environment; and derive a physical model pattern from the business pattern and existing documentation.

A third aspect of the present invention provides a computer program product for evaluating a computer environment, the computer program product comprising a computer readable storage device, and program instructions stored on the computer readable storage device, to: derive a set of use cases; select a predefined reference architecture using the set of defined use cases; derive a set of scenarios from the set of use cases; derive a set of system components from the set of derived scenarios; customize the selected reference architecture based on the set of derived components; discover installed components in the computer environment; derive a business pattern from at least one of the customized reference architecture and installed components; discover existing documentation related to the computer environment; and derive a physical model pattern from the business pattern and existing documentation.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computerized implementation according to an embodiment of the present invention;

FIG. 2 depicts a method flow diagram for deriving an expected physical layout of a computer system according to an embodiment of the present invention;

FIG. 3 depicts a system layout for the automated discovery aggregation solution according to an embodiment of the present invention;

FIG. 4 depicts a reference architecture component model for an example customer data center according to an embodiment of the invention;

FIG. 5 depicts a series of known use cases which are part of customer business requirements according to an embodiment of the present invention;

FIG. 6 depicts a partial logical diagram according to an embodiment of the present invention;

FIG. 7 depicts a partial hardware information template according to an embodiment of the present invention; and

FIG. 8 depicts a final physical model pattern according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the embodiments set forth herein. Rather, these illustrative embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. Furthermore, the term “developer” refers to any person who writes computer software. The term can refer to a specialist in one area of computer programming or to a generalist who writes code for many kinds of software.

As indicated above, embodiments of the present invention provide an approach for evaluating a computer environment. Specifically, actual deployed components of the computer systems are discovered and cross-referenced against a pre-determined functional architecture to produce a new physical pattern model to determine whether critical functions within the computer environment are not implemented or whether deployed components within the computer environment are over or under capacity.

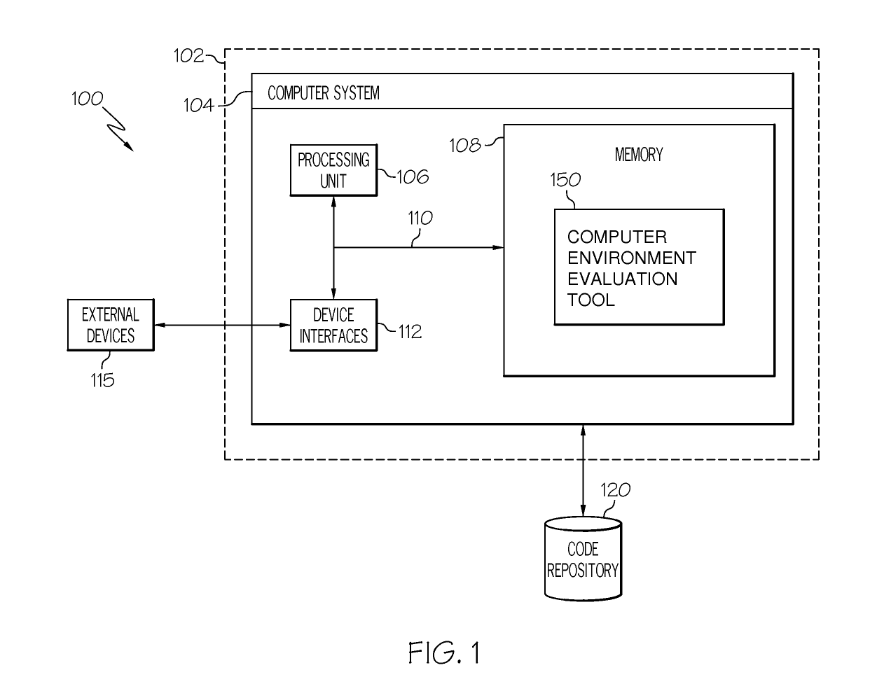

FIG. 1 depicts a computerized implementation 100 according to an embodiment of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communication occurs via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing a passport according to the present invention. It should be understood that any other computers implemented under the present invention may have different components/software, but will perform similar functions. As shown, computer system 104 includes a processing unit 106, memory 108 for storing a computer environment evaluation tool 150, a bus 110, and device interfaces 112.

Processing unit 106 collects and routes signals representing outputs from external devices 115 (e.g., a keyboard, a pointing device, a display, a graphical user interface, etc.) to computer environment evaluation tool 150. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG).)

In general, processing unit 106 executes computer program code, such as program code for operating computer environment evaluation tool 150, which is stored in memory 108 and/or code repository 120. While executing computer program code, processing unit 106 can read and/or write data to/from memory 108, and code repository 120. Code repository 120 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

The work environment is changing rapidly, but how those changes affect employee performance and productivity is not well understood. One notable finding is that the nature of collaboration has changed. Many jobs require more collaboration today than they did even a few years ago. Collaboration has an outsized impact on team performance. Levels of knowledge sharing have a significant impact on work-unit performance. As collaboration takes on a larger role in employees' daily work, companies seek ways to capture the critical knowledge and expertise workers possess, along with any ideas shared or decisions made during collaboration sessions.

In recent years, social networks have gained in popularity among Internet users. Social networks enable users to hold representative accounts (or profiles), and designate connections to other account holders, which may include friends, family members, or co-workers on the same social network. These connections determine a user's social graph, which defines the user and the others with whom the user is connected on the social network. Users can conduct a variety of activities based on their social graph, including sharing information and media with others, receiving updates from others, commenting on posted information, playing games, chatting, endorsing electronic information items such as websites or others' posts, etc.

As described herein, the present invention provides a methodology to automatically discover installed computer equipment and correlate it back to functional components (as part of a reference architecture) to validate what has been implemented is a true representation of what is expected. To that end, a reference architecture is created from available information. The available information may include a set of business requirements and use cases which are well understood. The components in the reference architecture are derived and actual installed components are discovered. A new physical pattern aggregation is derived based on differences between the actual components and reference architecture components.

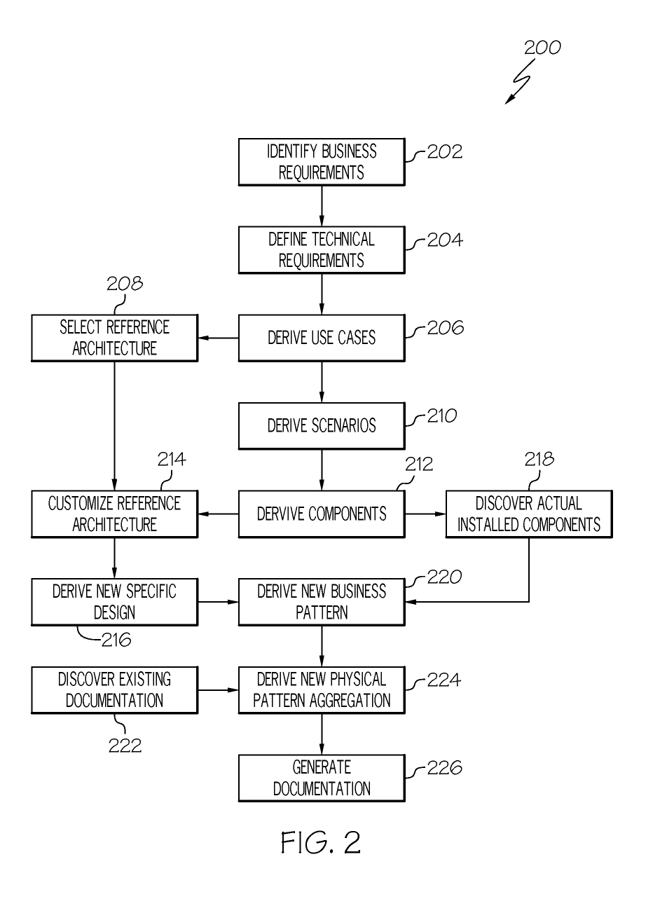

FIG. 2 depicts a method flow diagram for deriving an expected physical layout of a computer system according to an embodiment of the present invention. At 202, business requirements are identified. Business requirements describe what a system is supposed to do. They outline the critical activities that must be performed to meet the organizational objective(s) while remaining solution independent. Business requirements are typically directed to more non-technical aspects.

At 204, technical requirements are defined based on the identified business requirements. A technical requirement pertains to the technical aspects that a system must fulfill, such as performance-related issues, reliability issues, and availability issues. These types of requirements are often called quality of service (QoS) requirements, service-level requirements, or non-functional requirements. In short, technical requirements describe how a system needs to do something and generally come in two forms: how the architecture of the system should work, and how it should interface with other systems and software.

At 206, use cases are derived based on the defined technical requirements. A use case is a methodology used in system analysis to identify, clarify, and organize the defined technical requirements. The use case is made up of a set of possible sequences of interactions between systems and users in a particular environment and related to a particular goal. The use case should contain all system functions that have significance to the users.

At 208, a reference architecture is selected based on the derived use cases. A reference architecture provides a template, often based on the generalization of a set of solutions. These solutions may have been generalized and structured for the depiction of one or more architecture components based on the harvesting of a set of business patterns that have been observed in a number of successful implementations. Further, it shows how to compose these parts together into a solution.

At 210, scenarios are derived from the use cases. A use case represents the actions that are required to enable or abandon a goal. A use case has multiple “paths” that can be taken by any user at any one time. A scenario is a single path through the use case. At 212, components are derived from the scenarios. By identifying one or more scenarios, the necessary components may be derived that are needed to execute each scenario. At 214, the selected reference architecture may be customized based on the derived components. At 216, a new specific design is derived based on the customized reference architecture.

At 218, actual installed components are discovered. In one example, the installed components may be discovered using automated discovery tools known in the art. The third party discovery tools are tools which can scan systems to confirm the existence, type, configuration, etc., of systems and their components. In other examples, the installed components may be discovered by other means. Using the specific design and actual installed components, a new business pattern is derived at 220. A business pattern is a common design that can be executed repeatedly by various business models in different environments. A business pattern is a broad term that has to do with the rules that govern how systems personnel go about creating products for different types of business operations. The exact nature of the pattern will vary, depending on the type of business under consideration and the intended function of the system.

At 222, existing documentation related to the installed components is discovered. Valid documentation may be confirmed by the results from the automated scanning tool described above. The existing documentation may not be accurate, but may have some building blocks necessary to describe the operation of the business, system components, and system component locations. Combining the information from the existing documentation and using the new business pattern, a new physical pattern is derived at 224 which provides necessary information for a system deployment. At 226, documentation related to the new physical pattern may be generated. The documentation may include written text, diagrams, images, or the like.

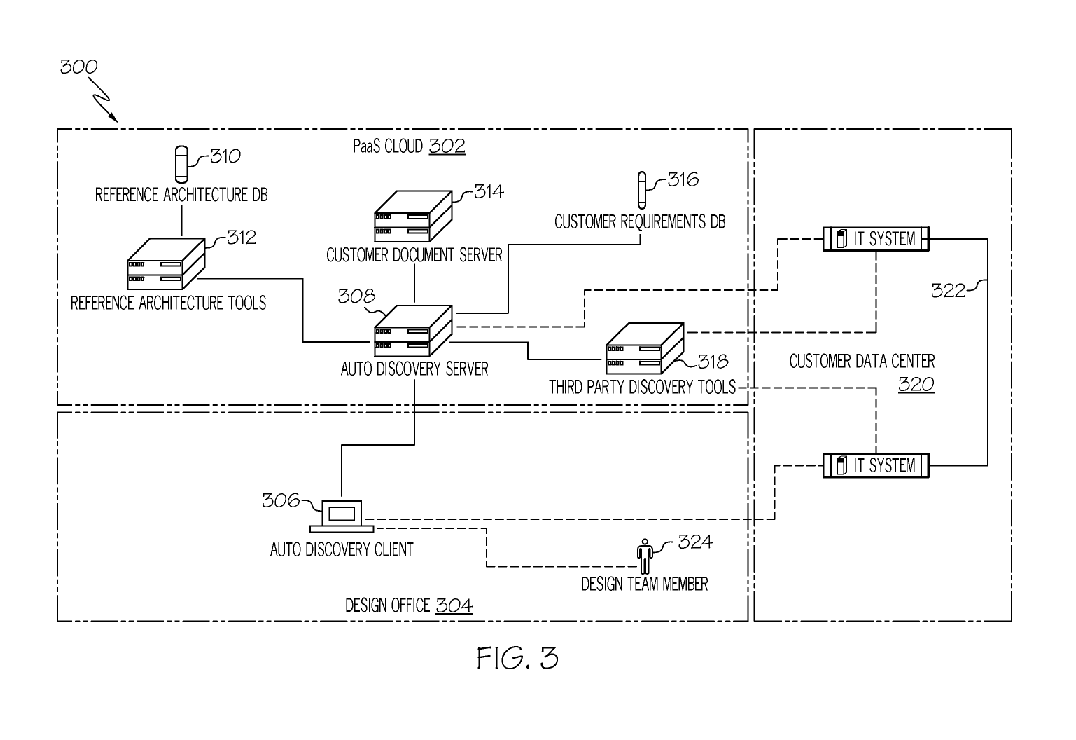

The character of the invention may be best understood with reference to FIGS. 3-8. FIG. 3 depicts a system layout for the automated discovery aggregation solution according to an embodiment of the present invention. As shown, the system layout includes Platform as a Service (PaaS) cloud 302, design office 304, and customer data center 320. Design office 304 includes design team member 324 and auto discovery client 306. Design team member 324 operates auto discovery client 306 to interface with auto discovery server 308.

PaaS cloud 302 includes auto discovery server 308, reference architecture database (DB) 310, reference architecture tools 312, customer document server 314, customer requirements database (DB) 316, and third party discovery tools 318. Reference architecture database 310 may store known standard reference architectures for typical business patterns. Reference architecture tools 312 may be employed in the development of reference architectures. Customer document server 314 may contain any existing documentation related to the existing system. The documentation may include text, diagrams, images, or the like. Customer requirements database 316 may store a collection of customer use cases. Third party discovery tools 318 may scan systems to confirm the existence, type, configuration, etc., of systems and their components. As shown, customer data center 320 includes information technology (IT) system 322.

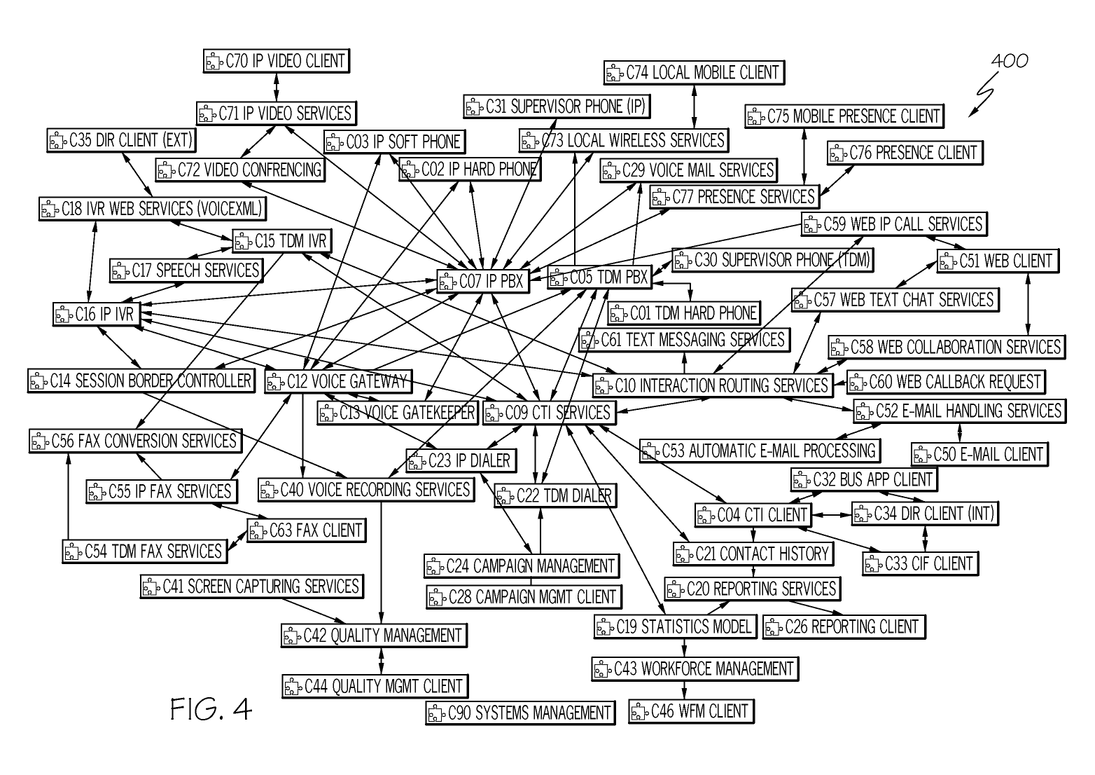

FIG. 4 depicts a reference architecture component model 400 for an example customer data center according to an embodiment of the present invention. The reference architecture component model 400 provides a template solution for an architecture for the example customer data center. The reference architecture component model 400 includes the functional components that may be required to provide the customer solution.

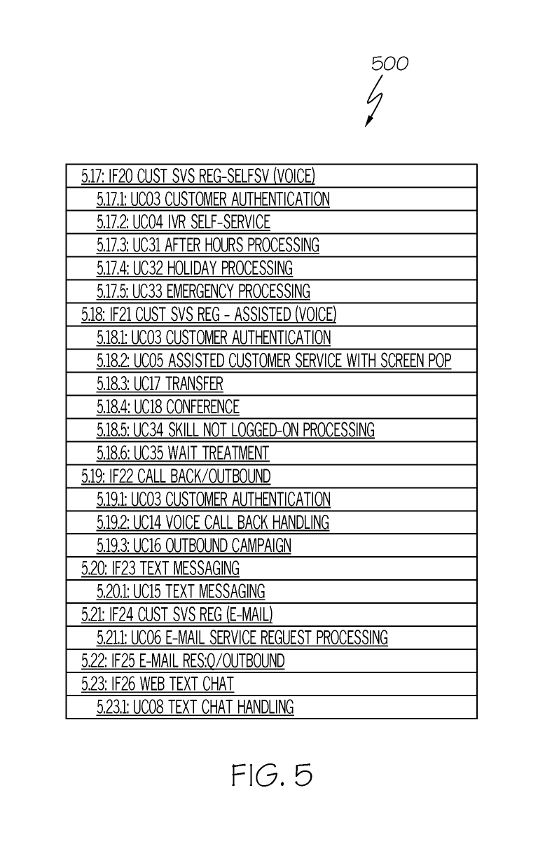

FIG. 5 depicts a series of known use cases 500 which are part of customer business requirements according to an embodiment of the present invention. Managing the physical, virtual, network, and compute infrastructures within data centers has become an increasingly complex challenge. The problem is exacerbated by rising numbers of subscribers, new applications, and growing bandwidth demands. Use cases are derived for administrators to ensure the availability of data center infrastructure. Assurance is a critical component of data center operations as it helps ensure that services meet customer standards, maintenance procedures, compliance and service-level agreements (SLAs).

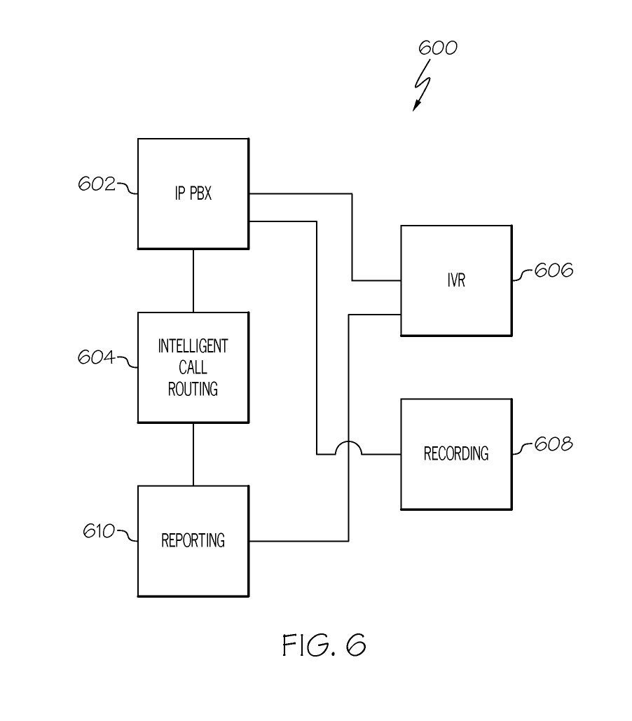

FIG. 6 depicts a partial logical diagram 600 according to an embodiment of the present invention. The partial logical diagram 600 may be derived from customer requirements related to receiving calls to customer data center 320. The partial logical diagram 600 includes IP PBX 602, Intelligent Call Routing (IRC) 604, IVR (or Interactive Voice Response) 606, recording 608, and reporting 610. IP PBX 602 is a private branch exchange (telephone switching system within an enterprise) that switches calls between VoIP (voice over Internet Protocol or IP) users on local lines while allowing all users to share a certain number of external phone lines. IRC 604 is a term for routing done by software that attempts to identify the caller and direct them to an appropriate agent. IVR 606 is an automated telephony system that interacts with callers, gathers information and routes calls to the appropriate recipient. Call recording 608 may be done for compliance to random call sampling for quality monitoring. Call reporting 610 may provide critical metrics which may be used in making business decisions.

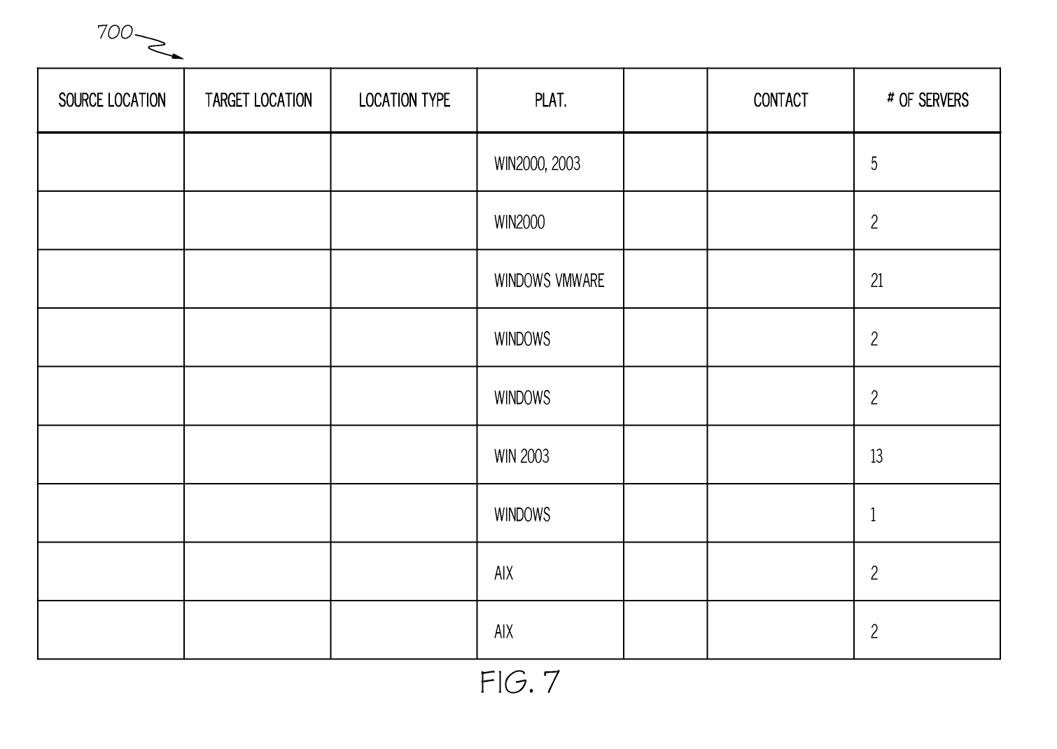

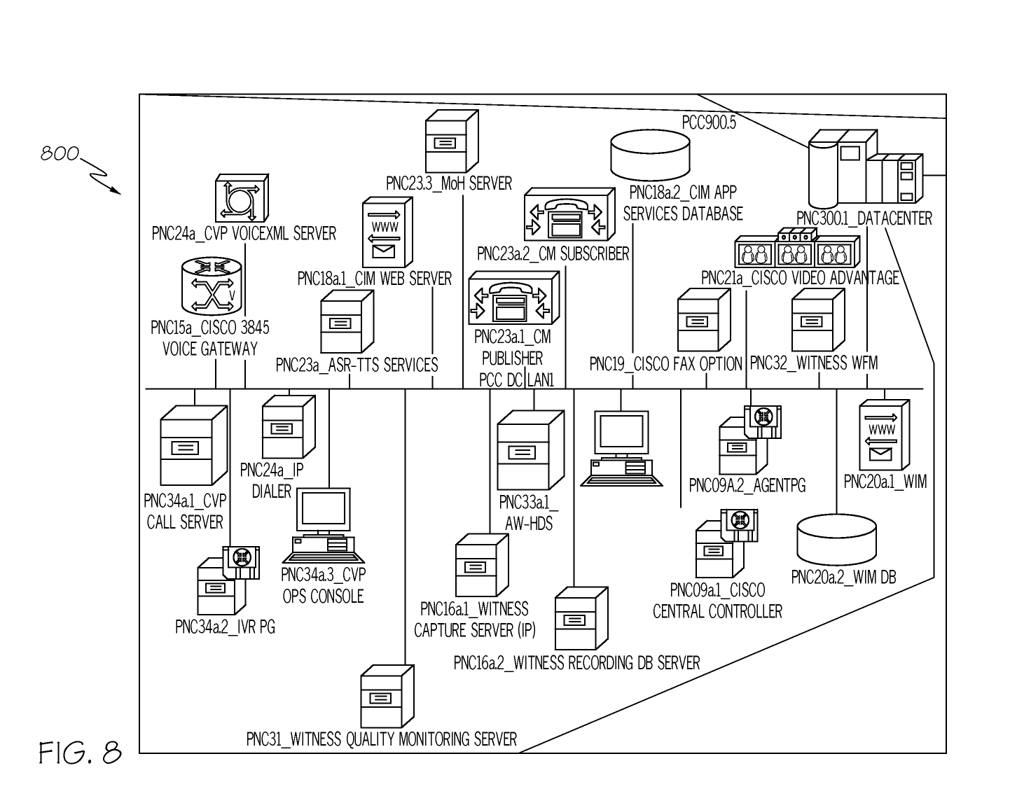

FIG. 7 depicts a partial hardware information template 700 according to an embodiment of the present invention. The partial hardware information template 700 is derived from existing documentation and third party discovery tools and includes server information related to customer data center 320. Based on all the above information, a final physical model pattern may be created by auto discovery server 308. FIG. 8 depicts a final physical model pattern 800 according to an embodiment of the present invention. The final physical model pattern 800 may be used to implement customer data center 320 according to customer requirements, standards, maintenance procedures, and compliance.

It will be appreciated that the method process flow diagram of FIG. 2 represents a possible implementation of a process flow for evaluating a computer environment, and that other process flows are possible within the scope of the invention. The method process flow diagram discussed above illustrates the architecture, functionality, and operation of possible implementations of systems, methods, and computer program products according to various embodiments of the present invention. In this regard, each portion of the flowchart may represent a module, segment, or portion of code, which comprises one or more executable instructions for implementing the specified logical function(s). It will also be noted that each block of the flowchart illustration can be implemented by special purpose hardware-based systems that perform the specified functions or acts.

Further, it can be appreciated that the approaches disclosed herein can be used within a computer system for evaluating a computer environment. In this case, as shown in FIG. 1, computer environment evaluation tool 150 can be provided, and one or more systems for performing the processes described in the invention can be obtained and deployed to computer infrastructure 102 (FIG. 1). To this extent, the deployment can comprise one or more of: (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computer system 104 may be practiced in distributed computing environments where tasks are performed by remote processing devices that are linked through a communication network. In a distributed computing environment, program modules may be located in both local and remote computer storage media including memory storage devices.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, computer environment evaluation tool 150 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network, and/or a wireless network). The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create a means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided with this invention an approach for evaluating a computer environment. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for evaluating a computer environment, comprising the computer-implemented steps of:
deriving a set of use cases;
selecting a predefined reference architecture using the set of defined use cases;
deriving a set of scenarios from the set of use cases;
deriving a set of system components from the set of derived scenarios;
customizing the selected reference architecture based on the set of derived components;
discovering installed components in the computer environment;
deriving a business pattern from at least one of the customized reference architecture and installed components;
discovering existing documentation related to the computer environment; and
deriving a physical model pattern from the business pattern and existing documentation.

2. The method of claim 1, further comprising the computer-implemented steps of identifying a set of business requirements and deriving a set of technical requirements based on the set of identified business requirements.

3. The method of claim 2, wherein the set of use cases are derived from the set of derived technical requirements.

4. The method of claim 1, wherein the predefined reference architecture is selected from a collection of predefined reference architectures.

5. The method of claim 1, wherein the installed components in the computer environment are discovered using automated discovery tools.

6. The method of claim 1, wherein the existing documentation related to the computer environment comprises at least one of written text, one or more diagrams, or one or more images.

7. The method of claim 1, the computer environment is related to a data center.

8. A system for evaluating a computer environment, comprising:
a memory medium comprising program instructions;
a bus coupled to the memory medium; and
a processor, for executing the program instructions, coupled to the memory medium that when executing the program instructions causes the system to:
derive a set of use cases;
select a predefined reference architecture using the set of defined use cases;
derive a set of scenarios from the set of use cases;
derive a set of system components from the set of derived scenarios;
customize the selected reference architecture based on the set of derived components;
discover installed components in the computer environment;
derive a business pattern from at least one of the customized reference architecture and installed components;
discover existing documentation related to the computer environment; and
derive a physical model pattern from the business pattern and existing documentation.

9. The system of claim 8, the memory medium further comprising instructions to identify a set of business requirements and derive a set of technical requirements based on the set of identified business requirements.

10. The system of claim 9, wherein the set of use cases are derived from the set of derived technical requirements.

11. The system of claim 8, wherein the predefined reference architecture is selected from a collection of predefined reference architecture.

12. The system of claim 8, wherein the installed components in the computer environment are discovered using automated discovery tools.

13. The system of claim 8, wherein the existing documentation related to the computer environment at least one of written text, one or more diagrams, or one or more images.

14. The system of claim 8, the memory medium further comprising instructions to generate documentation related to the physical model pattern.

15. A computer program product for evaluating a computer environment, the computer program product comprising a computer readable storage device, and program instructions stored on the computer readable storage device, to:
derive a set of use cases;
select a predefined reference architecture using the set of defined use cases;
derive a set of scenarios from the set of use cases;
derive a set of system components from the set of derived scenarios;
customize the selected reference architecture based on the set of derived components;
discover installed components in the computer environment;
derive a business pattern from at least one of the customized reference architecture and installed components;
discover existing documentation related to the computer environment; and
derive a physical model pattern from the business pattern and existing documentation.

16. The computer program product of claim 15, further comprising program instructions stored on the computer readable storage device to identify a set of business requirements and derive a set of technical requirements based on the set of identified business requirements.

17. The computer program product of claim 16, wherein the set of use cases are derived from the set of derived technical requirements.

18. The computer program product of claim 15, wherein the predefined reference architecture is selected from a collection of predefined reference architecture.

19. The computer program product of claim 15, wherein the installed components in the computer environment are discovered using automated discovery tools.

20. The computer program product of claim 15, wherein existing documentation related to the computer environment contains at least one of written text, one or more diagrams, or one or more images.
